(19) United States
(12) Patent Application Publication
(10) Pub. No.: US 2008/0308220 A1
(43) Pub. Date: Dec. 18, 2008

(54) IN-MOLD FORMING MOLD, IN-MOLD FORMING APPARATUS, AND IN-MOLD FORMING METHOD

(75) Inventors: Hirofumi Igarashi, Chiryu-shi (JP); Takumi Kudou, Edogawa-ku (JP); Masaaki Iwakiri, Edogawa-ku (JP); Yasuyuki Ohara, Nagoya-shi (JP); Isamu Sakayori, Edogawa-ku (JP)

Correspondence Address: SUGHRUE MION, PLLC, 2100 PENNSYLVANIA AVENUE, N.W., SUITE 800, WASHINGTON, DC, 20037, US

(73) Assignees: KOTO ENGRAVING CO., LTD., Tokyo (JP); TSUCHIYA CO., LTD., Aichi (JP)

(21) Appl. No.: 11/854,399

(22) Filed: Sep. 12, 2007

(30) Foreign Application Priority Data
Sep. 15, 2006 (JP) 2006-251622

(51) Int. Cl. B29C 45/00; B29C 45/04

(52) U.S. Cl. 156/245; 425/575; 264/294

(57) ABSTRACT

A film coated with a metal foil is embossed beforehand by a film shaping male mold to impart to the film a shape conformed to a formed article. The film shaping male mold and an injection molding male mold are slid, and injection molding is performed, with the embossed film coated with the metal foil being sandwiched between the injection molding male mold and a shaping female mold. As a result, the metal foil of the film coated with the metal foil is transferred to a product having a deeply concavo-convex surface, without damage to the metal foil, with the quality of the product being ensured.

The entire disclosure of Japanese Patent Application No. 2006-251622 filed Sep. 15, 2006 is expressly incorporated by reference herein.

### BACKGROUND OF THE INVENTION

1. Field of the Invention

This invention relates to an in-mold forming mold for decorating resin with the film pattern of a patterned film, simultaneously with injection molding of the resin.

The present invention also relates to an in-mold forming apparatus for decorating resin with the film pattern of a patterned film, simultaneously with injection molding of the resin.

The present invention further relates to an in-mold forming method for decorating resin with the film pattern of a patterned film, simultaneously with injection molding of the resin.

2. Description of the Related Art

In-mold forming is known by which a patterned film provided with a film pattern (for example, a film coated with a metal foil) is inserted into a mold, and the film pattern (the metal foil) is applied for decoration (transferred) by heat and pressure during injection molding. With in-mold forming, a decorated formed article is obtained without plating or painting. Thus, this technique is advantageous to the environment, and has few restrictions as to the shape of the formed article. For these reasons, in-mold forming is finding use in many fields.

In performing in-mold forming with the use of a patterned film (e.g., a film coated with a metal foil), it is common practice to pass the film coated with the metal foil between a stationary mold and a moving mold, and inject resin into these molds where the film coated with the metal foil has been interposed, thereby obtaining an in-mold formed article (see Japanese Unexamined Patent Publication No. 2001-277294 and Japanese Unexamined Patent Publication No. 1984-202830). With the technologies disclosed in these patent documents, the formed article is obtained, for example, by passing the film coated with the metal foil, which is in a continuous shape, between the stationary mold and the moving mold, and injecting the resin between these molds and the continuous film coated with the metal foil. By carrying out in-mold forming with the use of the film coated with the metal foil, the surface of the product can be decorated with the metal foil transferred under heat and pressure during injection molding, regardless of the shape of the surface of the product, even if this surface has irregularities other than a stepped portion. With these technologies, the continuous film coated with the metal foil is heated prior to injection molding in order to prevent the breakage of the metal foil.

In recent years, product diversification and differentiation have been stepped up. In the field of in-mold formed articles as well, there has been a demand for in-mold forming of products having a deeply concavo-convex shape. By preheating a continuous film coated with a metal foil, in-mold forming can be performed for a surface having some irregularity, without breakage caused to the metal foil. Even when the continuous film coated with the metal foil is preheated, however, sufficient quality cannot be ensured for a product having a deeply concavo-convex surface by reliably transferring the metal foil to the product. Thus, there is a strong demand for the establishment of an in-mold forming technology which can transfer the metal foil to the product having a deeply concavo-convex surface while ensuring the quality of the product.

### SUMMARY OF THE INVENTION

The present invention has been accomplished in the light of the above-mentioned circumstances. It is an object of the present invention to provide an in-mold forming mold, an in-mold forming apparatus, and an in-mold forming method, each of which can decorate even a product having a deeply concavo-convex surface with a film pattern while ensuring the quality of the product.

A first aspect of the present invention, for attaining the above object, is an in-mold forming mold, comprising:

a male mold body;

a film shaping male mold and an injection molding male mold, provided adjacently in the male mold body, for embossing, beforehand, a patterned film with a shape conformed to a formed article,

the film shaping male mold and the injection molding male mold being supported on the male mold body to be movable in a reciprocating manner in a direction in which the film shaping male mold and the injection molding male mold are arranged side by side;

a female mold body;

a shaping female mold provided, in the female mold body, to oppose the film shaping male mold or the injection molding male mold upon reciprocating movement of the film shaping male mold and the injection molding male mold; and

moving means, provided on the male mold body, for moving the film shaping male mold and the injection molding male mold to a position where the film shaping male mold or the injection molding male mold is opposed to the shaping female mold.

According to the first aspect, embossing with the shape conformed to the formed article is performed by the film shaping male mold of the male mold body and the shaping female mold of the female mold body. Moreover, the film shaping male mold and the injection molding male mold are moved by the moving means, with the position of the patterned film being fixed, to bring the injection molding male mold and the shaping female mold into face-to-face relationship, and injection molding is carried out by the injection molding male mold and the shaping female mold. Thus, even a product having a deeply concavo-convex surface can be decorated with the film pattern by the single mold, without damage to the film pattern, with the position of the patterned film being fixed, and with the quality of the product being ensured.

When embossing is performed for a product having a deeply concavo-convex surface, tension which returns the surface to a flat surface acts on the patterned film upon mold release. However, the position of the patterned film is fixed, and thus tension acting on the patterned film is only the restoring force of the patterned film itself. Compared with a case where the patterned film is fed, embossing with a deeply concavo-convex surface becomes possible, without increase in the tensile force.

A second aspect of the present invention is the in-mold forming mold according to the first aspect, wherein the direction in which the film shaping male mold and the injection molding male mold are arranged side by side is a direction intersecting a feeding direction of the patterned film.

According to the second aspect, the film shaping male mold and the injection molding male mold are arranged side by side in a direction intersecting the feeding direction of the patterned film. Thus, the space in the feeding direction of the patterned film can be decreased.

A third aspect of the present invention is the in-mold forming mold according to the first or second aspect, wherein the film shaping male mold and the injection molding male mold are provided in the male mold body via a heat insulating material.

According the third aspect, the film shaping male mold and the injection molding male mold are provided in the male mold body via the heat insulating material. Thus, control can be exercised independently of the temperature for embossing with the shape conformed to the formed article.

A fourth aspect of the present invention is the in-mold forming mold according to any one of the first to third aspects, wherein the male mold body is provide with a slide guide; the film shaping male mold and the injection molding male mold are integrally supported on the slide guide; a body of an air cylinder, as the moving means, having a drive portion disposed along and parallel to the slide guide is provided in the male mold body; and the film shaping male mold and the injection molding male mold which have been integrated are mounted on the drive portion of the air cylinder.

According to the fourth aspect, the drive portion of the air cylinder is disposed along and parallel to the slide guide. Thus, the space in the moving direction of the film shaping male mold and the injection molding male mold can be diminished.

A fifth aspect of the present invention is the in-mold forming mold according to any one of the first to fourth aspects, wherein the patterned film which is embossed and injection molded by the male mold body and the female mold body is a film coated with a metal foil; and the metal foil of the film coated with the metal foil is transferred, simultaneously with forming, to obtain the formed article decorated with the metal foil.

According to the fifth aspect, the formed article having the metal foil transferred thereto can be obtained.

A sixth aspect of the present invention is an in-mold forming apparatus, comprising:

a stationary support stand for supporting the male mold body according to any one of the first to fourth aspects;

a moving support stand for supporting the female mold body according to any one of the first to fourth aspects to oppose the male mold body;

material pressure-feeding means for pressure-feeding a material for the formed article to a male mold side of the male mold body supported by the stationary support stand;

film feeding means, provided on a moving support stand side, for feeding the patterned film between the male mold body and the female mold body; and

control means for interlocking a clamping action by movement of the moving support stand, an action of moving the film shaping male mold and the injection molding male mold by the moving means, an action of feeding the patterned film by the film feeding means, and an action of pressure-feeding the material for the formed article by the material pressure-feeding means,

the in-mold forming apparatus being arranged to perform actions of
film shaping and embossing, by the film shaping male mold and the shaping female mold, of the patterned film to impart the shape conformed to the formed article, and
forming for obtaining the formed article decorated with a pattern of the patterned film by carrying out injection molding, while sandwiching the embossed patterned film between the injection molding male mold and the shaping female mold, after moving the film shaping male mold and the injection molding male mold upon mold release,
   and also to feed the patterned film upon mold release after obtainment of the formed article and repeat the above actions, thereby obtaining the decorated formed articles continuously.

According to the sixth aspect, the film shaping male mold and the injection molding male mold are moved by the moving means, with the position of the patterned film being fixed, to bring the injection molding male mold and the shaping female mold into face-to-face relationship, and injection molding is carried out by the injection molding male mold and the shaping female mold. Thus, even a product having a deeply concavo-convex surface can be decorated with the film pattern by the single mold, without damage to the film pattern, with the position of the patterned film being fixed, and with the quality of the product being ensured.

It is permissible to support the female mold body by the stationary support stand, instead of supporting the male mold body by the stationary support stand, and to support the male mold body by the moving support stand, instead of supporting the female mold body by the moving support stand.

A seventh aspect of the present invention is the in-mold forming apparatus according to the sixth aspect, wherein the patterned film is a film coated with a metal foil, and the metal foil of the film coated with the metal foil is transferred, simultaneously with forming, to obtain the formed article decorated with the pattern of the patterned film.

According to the seventh aspect, the formed article having the metal foil transferred thereto can be obtained.

An eighth aspect of the present invention is an in-mold forming method, comprising:

embossing, beforehand, a patterned film with a shape conformed to a formed article by a film shaping male mold;

moving the film shaping male mold and a forming mold by an identical mold; and

performing injection molding, while interposing the embossed patterned film in the forming mold, to obtain the formed article decorated with a pattern of the patterned film.

According to the eighth aspect, the film shaping male mold and the injection molding male mold are moved by the moving means, with the position of the patterned film being fixed, to bring the injection molding male mold and the shaping female mold into face-to-face relationship, and injection molding is carried out by the injection molding male mold and the shaping female mold. Thus, even a product having a deeply concavo-convex surface can be decorated with the film pattern by the single mold, without damage to the film pattern, with the position of the patterned film being fixed, and with the quality of the product being ensured.

A ninth aspect of the present invention is the in-mold forming method according to the eight aspect, wherein a shaping male mold opposing the film shaping male mold and the forming mold is a common shaping female mold, and only the film shaping male mold and the forming mold are moved by the identical mold.

According to the ninth aspect, a product having a deeply concavo-convex surface can be decorated with the film pattern simply upon movement of the film shaping male mold and the forming mold.

A tenth aspect of the present invention is the in-mold forming method according to the eighth or ninth aspect, wherein the patterned film which is embossed and injection molded by a male mold body and a female mold body is a film coated with a metal foil; and the metal foil of the film coated with the metal foil is transferred, simultaneously with forming, to obtain the formed article decorated with the metal foil.

According to the tenth aspect, the formed article having the metal foil transferred thereto can be obtained.

As noted above, the in-mold forming mold of the present invention can serve as an in-mold forming mold which enables even a product having a deeply concavo-convex surface to be decorated with a film pattern, with the quality of the product being ensured.

Moreover, the in-mold forming apparatus of the present invention can serve as an in-mold forming apparatus which enables even a product having a deeply concavo-convex surface to be decorated with a film pattern, with the quality of the product being ensured.

Furthermore, the in-mold forming method of the present invention can serve as an in-mold forming method which enables even a product having a deeply concavo-convex surface to be decorated with a film pattern, with the quality of the product being ensured.

### BRIEF DESCRIPTION OF THE DRAWINGS

For a more complete understanding of the present invention and the advantages thereof, reference is now made to the following descriptions in conjunction with the accompanying drawings.

FIG. 1 is a schematic side view of an in-mold forming apparatus for performing an in-mold forming method according to an embodiment of the present invention.

FIG. 2 is a perspective view of an in-mold forming mold according to the embodiment of the present invention.

FIG. 3 is a perspective view of the in-mold forming mold according to the embodiment of the present invention.

FIG. 4 is a perspective view of the in-mold forming mold according to the embodiment of the present invention.

FIG. 5 is an external outline view of an example of an in-mold formed article.

FIGS. 6A and 6B are development views showing the molding surfaces of the in-mold forming mold in which a film shaping male mold and a shaping female mold are opposed to each other.

FIG. 7 is a view taken along line VII-VII in each of FIGS. 6A and 6B.

FIG. 8 is a view taken along line VIII-VIII in each of FIGS. 6A and 6B.

FIGS. 9A and 9B are development views showing the molding surfaces of the in-mold forming mold in which an injection molding male mold and the shaping female mold are opposed to each other.

FIG. 10 is a view taken along line X-X in each of FIGS. 9A and 9B.

FIG. 11 is a view taken along line XI-XI in each of FIGS. 9A and 9B.

FIG. 12 is a process explanation drawing of the in-mold forming method according to the embodiment of the present invention.

FIG. 13 is a process explanation drawing of the in-mold forming method according to the embodiment of the present invention.

FIG. 14 is a process explanation drawing of the in-mold forming method according to the embodiment of the present invention.

FIG. 15 is a process explanation drawing of the in-mold forming method according to the embodiment of the present invention.

### DESCRIPTION OF THE PREFERRED EMBODIMENTS

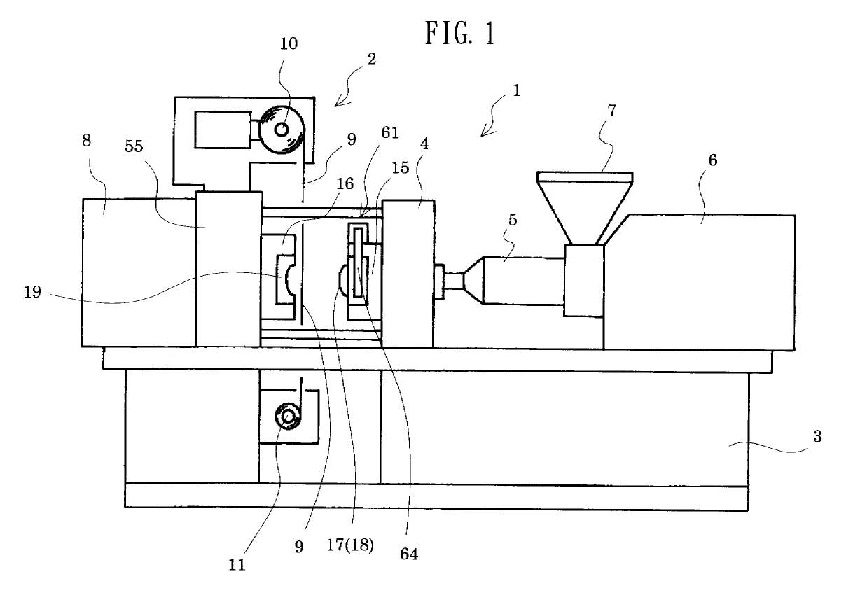

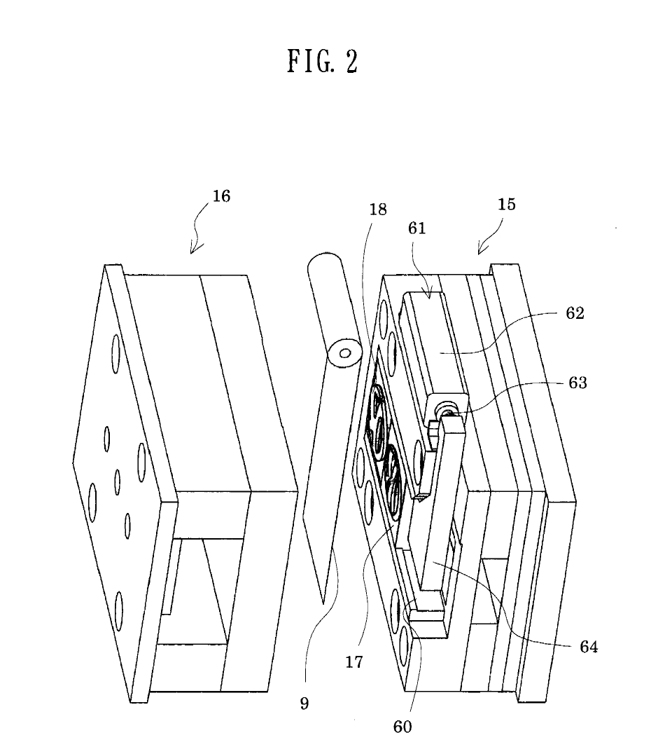

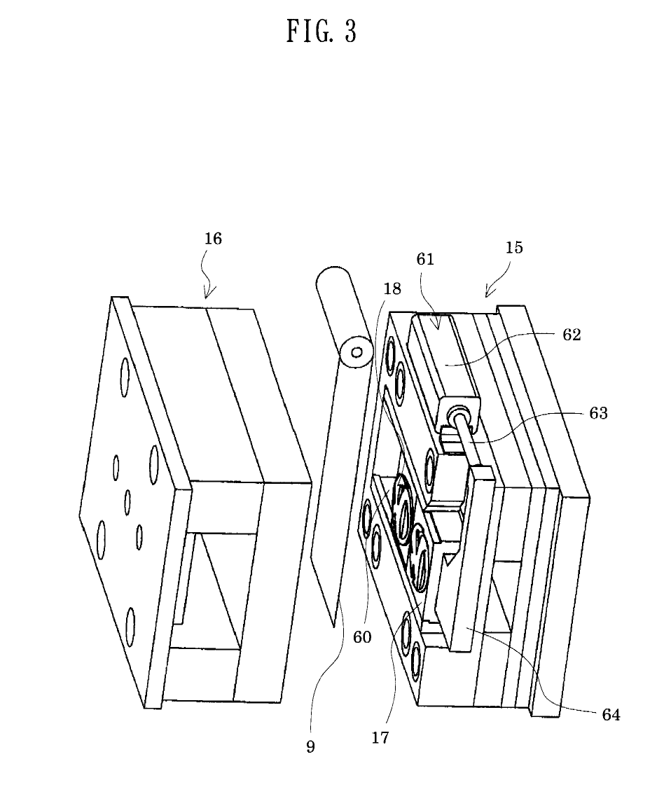

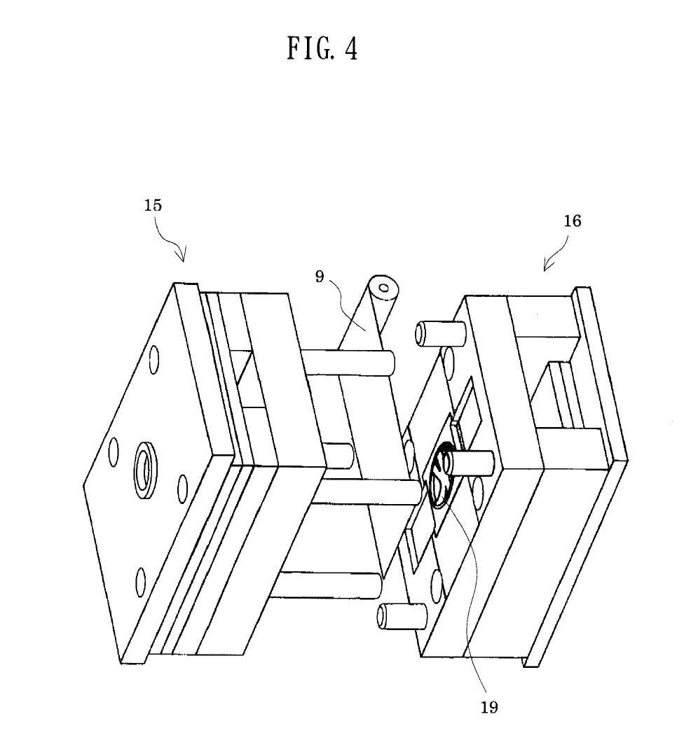

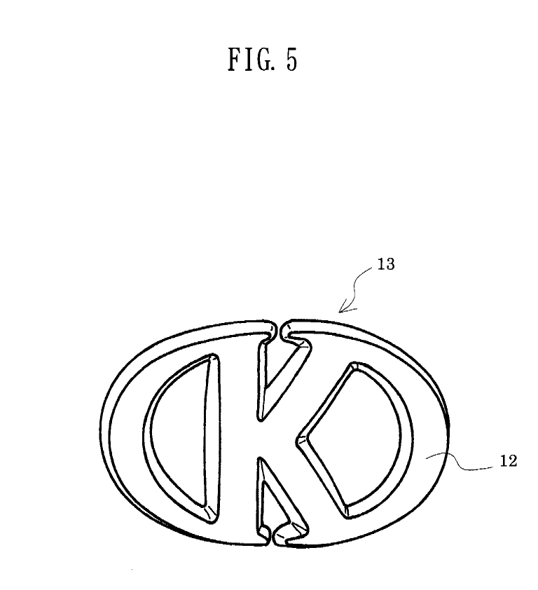

FIG. 1 shows a schematic side of an in-mold forming apparatus for performing an in-mold forming method according to an embodiment of the present invention. FIGS. 2 to 4 show the perspective status of an in-mold forming mold according to the embodiment of the present invention. FIGS. 2 and 3 show states in which a film shaping male mold and an injection molding male mold are visually recognized. FIG. 4 shows a state in which a shaping female mold is visually recognized. FIG. 5 shows an example of an in-mold formed article.

The schematic configuration of the in-mold forming apparatus will be described based on FIGS. 1 to 4.

As shown in FIG. 1, an in-mold forming apparatus 1 has a film feeding device 2, as a film feeding means, mounted on an injection molding machine. A stationary die plate 4 as a stationary support stand is provided on a base 3 of the in-mold forming apparatus 1. A barrel 5 for feeding molten resin is connected to the stationary die plate 4. The barrel 5 is equipped with a feeding means such as a screw (not shown), and the feeding means is driven in a feed direction by an injection drive portion 6. A resin material charged into a hopper 7 is heated and melted, and pressure-fed within the barrel 5 toward the stationary die plate 4 (material pressure-feeding means).

A clamping drive portion 8 is provided on a side opposite to the barrel 5 across the stationary die plate 4, and a moving die plate 55 as a moving support stand is provided on the clamping drive portion 8. The moving die plate 55 can be moved by the clamping drive portion 8 toward the stationary die plate 4. The film feeding device 2 is provided on the moving die plate 55. The film feeding device 2 is equipped with a feed roll 10 for paying out a film 9 coated with a metal foil (i.e., a patterned film), and a recovery roll 11 for recovering the film 9 coated with the metal foil after transfer of the metal foil. The film 9 coated with the metal foil is intermittently fed between the stationary die plate 4 and the moving die plate 55 by the film feeding device 2.

As shown in FIGS. 1 to 4, a stationary mold body 15 serving as a male mold body is fixed to the stationary die plate 4, while a moving mold body 16 serving as a female mold body and opposing the stationary mold body 15 is fixed to the moving die plate 55.

The stationary mold body 15 is provided with a film shaping male mold 17 for embossing, beforehand, the film 9 coated with the metal foil to impart thereto a shape conformed to a formed article. The stationary mold body 15 is also provided with an injecting molding male mold 18 disposed adjacent to the film shaping male mold 17. The film shaping male mold 17 and the injection molding male mold 18 are integrated via a connecting member (not shown).

A slide guide 60 orthogonal to (intersecting) the feed direction of the film 9 coated with the metal foil and extending in a horizontal direction is provided on the stationary mold body 15. The film shaping male mold 17 and the injection molding male mold 18 are movably supported, in an integral state, on the slide guide 60. A body 62 of an air cylinder 61, as a moving means, is mounted on an upper part of the stationary mold body 15. A drive rod 63, as a drive portion, is disposed on the body 62 parallel to and along the slide guide 60 (along the side-by-side arrangement direction of the film shaping male mold 17 and the injection molding male mold 18 in the integrated state).

An upper end portion of a connecting bar 64 is fixed to the leading end of the drive rod 63, and a lower end portion of the connecting bar 64 is fixed to the film shaping male mold 17 integrated with the injection molding male mold 18. That is, upon driving of the air cylinder 61, the drive rod 63 expands and contracts, so that the film shaping male mold 17 and the injection molding male mold 18 in the integrated state reciprocate along the slide guide 60 via the connecting bar 64.

The moving means is not limited to the air cylinder 61, and it is possible to apply other mechanism, such as a mechanical feed mechanism using a feed screw. Moreover, the position of provision of the air cylinder 61 is not limited to the position where the air cylinder 61 is provided in parallel with the film shaping male mold 17 and the injection molding male mold 18. It is possible to arrange the air cylinder 61 in series with the film shaping male mold 17 and the injection molding male mold 18. As noted here, the position where the moving means is provided can be changed variously in relation to other instruments.

On the other hand, the moving mold body 16 is mounted with a shaping female mold 19 which embosses, beforehand, the film 9 coated with the metal foil to impart thereto a shape conformed to the formed article, and which also performs injection molding while interposing the embossed film 9 coated with the metal foil. The shaping female mold 19 embosses the film 9 coated with the metal foil when the film shaping male mold 17 opposes the shaping female mold 19 for clamping, and performs injection molding, while holding the film 9 coated with the metal foil against the injection molding male mold 18, when the injection molding male mold 18 opposes the shaping female mold 19 for clamping, in accordance with the reciprocating movement of the film shaping male mold 17 and the injection molding male mold 18 in the integrated state.

It is also permissible to provide the shaping female molds in opposed relationship with the film shaping male mold 17 and the injection molding male mold 18, and reciprocate the respective shaping female molds in synchronization with the reciprocating movement of the film shaping male mold 17 and the injection molding male mold 18.

Molten resin is pressure-fed from the barrel 5 to the injection molding male mold 18, and a vacuum device (not shown) is connected to the shaping female mold 19. While the film shaping male mold 17 and the shaping female mold 19 are kept in an opposed state, the moving die plate 55 is sent toward the stationary die plate 4, and the stationary mold body 15 and the moving mold body 16 are clamped against each other, with the film 9 coated with the metal foil being sandwiched there between. At this time, the film 9 coated with the metal foil is embossed beforehand by the film shaping male mold 17 and the shaping female mole 19.

Then, the in-mold forming mold is opened and, with the position of the film 9 coated with the metal foil being fixed, the film shaping male mold 17 and the injection molding male mold 18 are moved. With the injection molding male mold 18 and the shaping female mold 19 opposing each other, the stationary mold body 15 and the moving mold body 16 are clamped against each other, and the molten resin is pressure-fed between the injection molding male mold 18 and the shaping female mold 19, with the result that a formed article 13 (see FIG. 5) having a metal foil 12 (see FIG. 5) transferred onto the surface thereof is obtained.

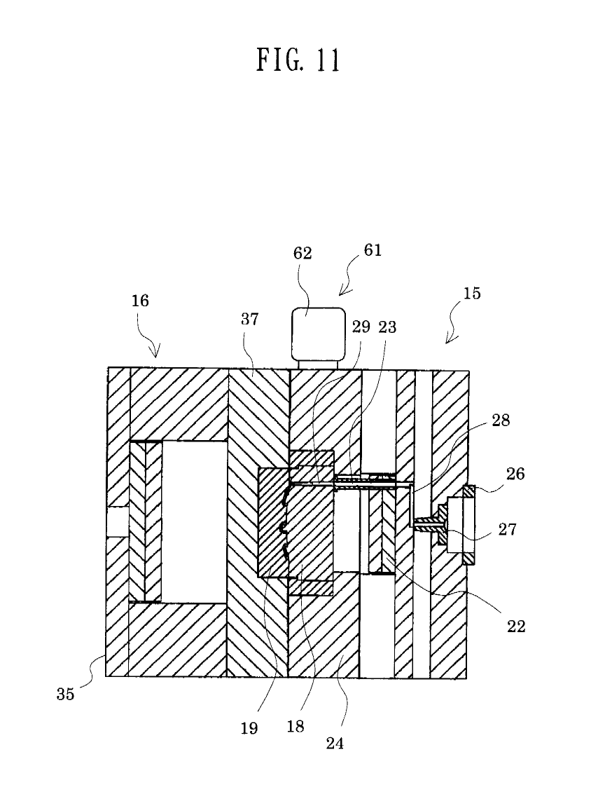

The stationary mold body 15 and the moving mold body 16, which constitute the in-mold forming mold, will be described concretely based on FIG. 2 to 4 and FIGS. 6A, 6B to FIG. 11.

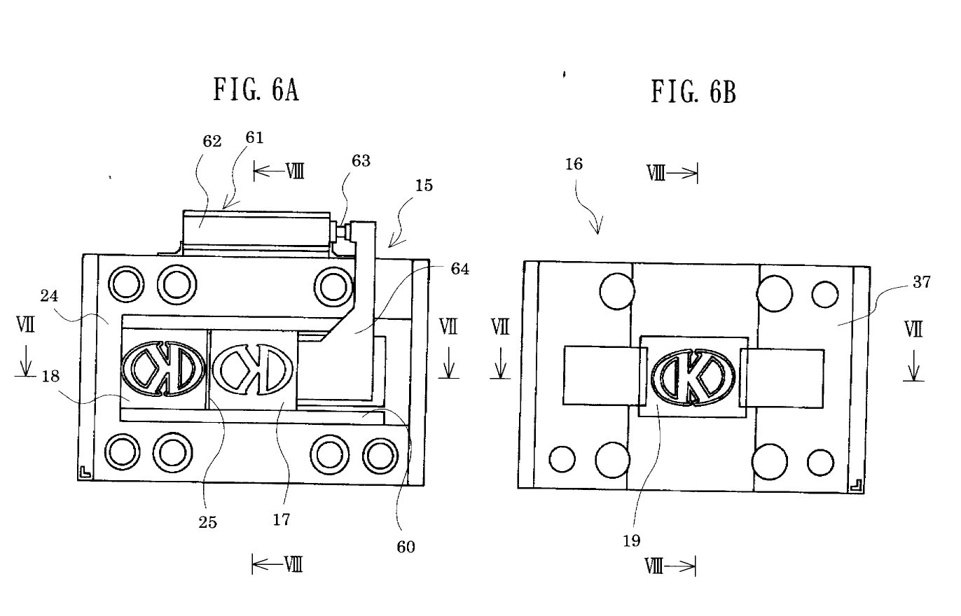

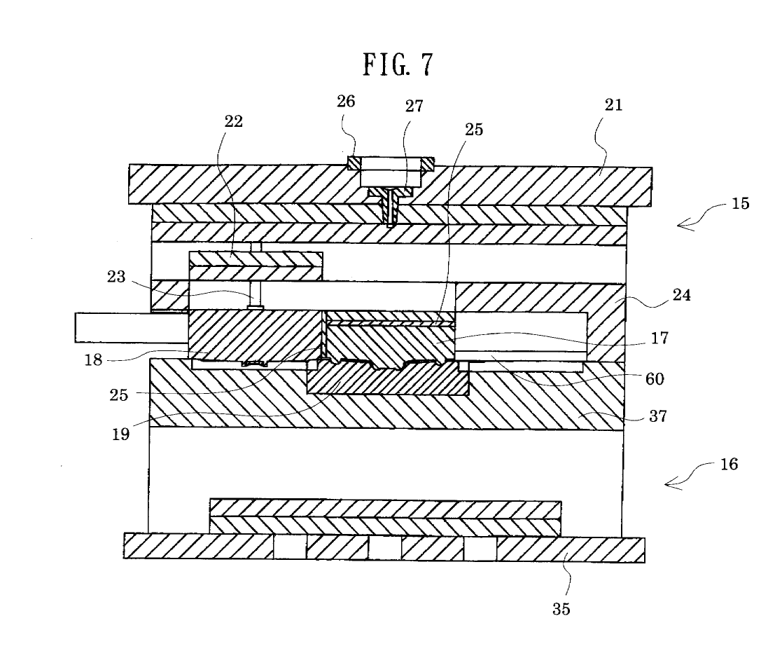

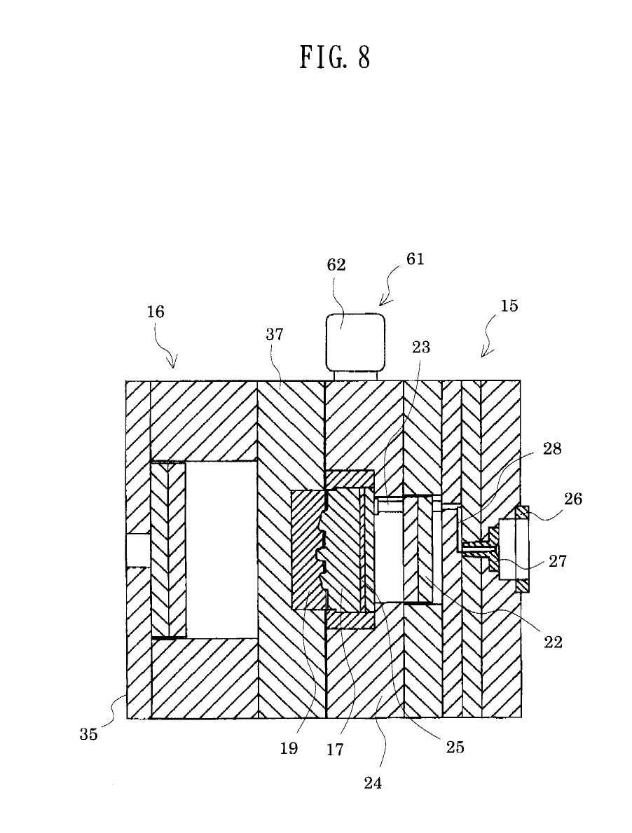

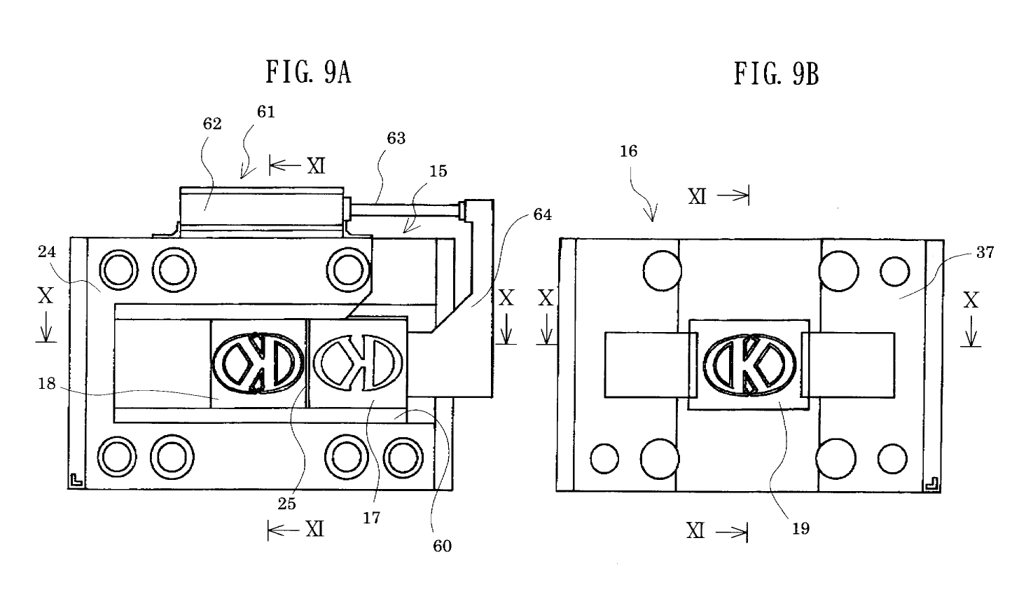

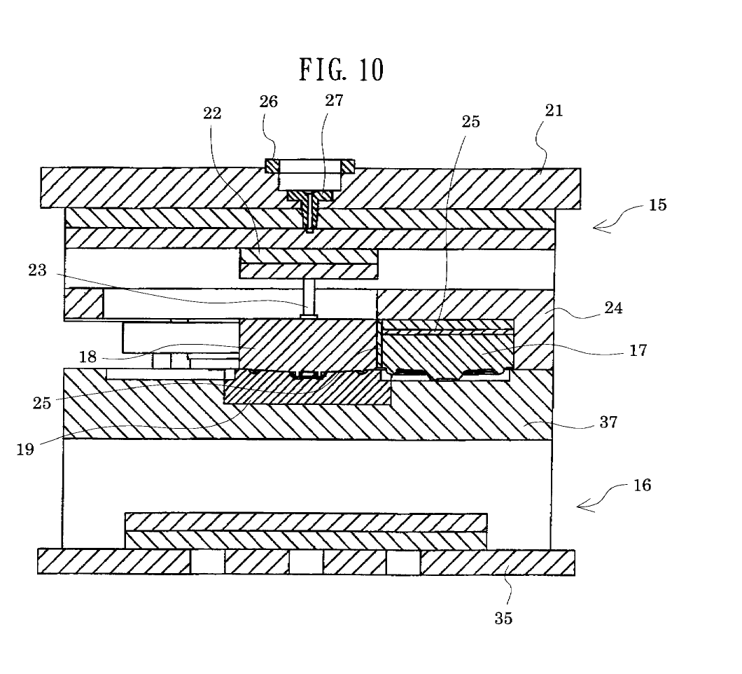

FIGS. 6A and 6B show a development status showing the molding surfaces of the in-mold forming mold in which the film shaping male mold and the shaping female mold are opposed to each other. FIG. 7 shows a view taken along line VII-VII in each of FIGS. 6A and 6B. FIG. 8 shows a view taken along line VIII-VIII in each of FIGS. 6A and 6B. FIGS. 9A and 9B show a development status showing the molding surfaces of the in-mold forming mold in which the injection molding male mold and the shaping female mold are opposed to each other. FIG. 10 shows a view taken along line X-X in each of FIGS. 9A and 9B. FIG. 11 shows a view taken along line XI-XI in each of FIGS. 9A and 9B.

The stationary mold body 15 has a stationary mounting plate 21 fixed to the stationary die plate 4 (see FIG. 1), and a male mold support 24 is fixed to the stationary mounting plate 21. The film shaping male mold 17 and the injection molding male mold 18 are mounted on the male mold support 24. The film shaping male mold 17 is fixed to the male mold support 24 via a heat insulating material 25.

Since the film shaping male mold 17 is mounted on the male mold support 24 via the heat insulating material 25, the film shaping male mold 17 can be maintained at a temperature for embossing of the film 9 coated with the metal foil, without influence from the temperature during injection molding, although the injection molding male mold 18 is mounted on the same male mold support 24.

The male mold support 24 is provided with the slide guide 60 extending in the right-and-left direction in FIG. 6A and FIG. 9, and the film shaping male mold 17 and the injection molding male mold 18 are movably supported, in the integral state, on the slide guide 60. The body 62 of the air cylinder 61 is mounted on an upper part of the male mold support 24 (stationary mold body 15), and the drive rod 63 is disposed on the body 62 along and parallel to the slide guide 60. The upper end portion of the connecting bar 64 is fixed to the leading end of the drive rod 63, and the lower end portion of the connecting bar 64 is fixed to the film shaping male mold 17 integrated with the injection molding male mold 18.

By providing the air cylinder 61 on the upper part of the male mold support 24, the film shaping male mold 17 and the injection molding male mold 18 can be reciprocated without expanding the space in the width direction of the film 9 coated with the metal foil.

For the slide guide 60, it is possible to use a configuration in which the slide surfaces of the film shaping male mold 17 and the injection molding male mold 18 are guided by a linear bearing, or a configuration in which a part of a ball or a needle roller is exposed at the guide surface, and the slide surfaces of the film shaping male mold 17 and the injection molding male mold 18 are guided by the rolling movement of the ball or the needle roller.

A locating ring 26, into which the nozzle of the barrel 5 (see FIG. 1) is fitted, is provided on the rear side (upper side in FIGS. 7 and 10, right-hand side in FIGS. 8 and 11) of the stationary mounting plate 21. In the stationary mounting plate 21, a sprue bushing 27 is provided in correspondence with the locating ring 26. A resin channel 28 communicating with the sprue bushing 27 is provided in the male mold support 24, and a channel block 22 is integrally provided in the injection molding male mold 18. A connecting channel 23 is provided in the channel block 22, and a resin inflow passage 29 in communication with the connecting channel 23 is provided in the injection molding male mold 18.

The resin channel 28 provided in the male mold support 24 is provided at a position where the resin channel 28 is connected to the connecting channel 23 of the channel block 22 (see FIG. 11) when the drive rod 63 of the air cylinder 61 is extended to cause the injection molding male mold 18 to oppose the shaping female mold 19 (the state in FIGS. 9A, 9B to 11). When the injection molding male mold 18 opposes the shaping female mold 19, the molten resin from the sprue bushing 27 is delivered through the resin channel 28 into the cavity between the injecting molding male mold 18 and the shaping female mold 19 via the connecting channel 23 and the resin inflow passage 29.

The moving mold body 16 has a moving mounting plate 35 fixed to the moving die plate 55 (see FIG. 1), and a female mold support 37 is fixed to the moving mounting plate 35. The shaping female mold 19 is mounted on the female mold support 37. A vacuum means (not shown) is connected to the shaping female mold 19 of the female mold support 37, and the cavity between the film shaping male mold 17 or the injecting molding male mold 18 and the shaping female mold 19 is brought to a predetermined vacuum atmosphere by the vacuum means.

In the in-mold forming mold described above, the film 9 coated with the metal foil is embossed beforehand by the film shaping male mold 17 and the shaping female mold 19 to impart a shape conformed to a desired formed article to the film 9 coated with the metal foil. In the same mold, the film shaping male mold 17 and the injecting molding male mold 18 are moved, without dispatch of the film 9 coated with the metal foil. The embossed film 9 coated with the metal foil is sandwiched between the injection molding male mold 18 and the shaping female mold 19. In this state, injection molding is carried out to obtain a formed article having the metal foil 12 of the film 9 coated with the metal foil transferred thereto.

Since the injection molding is carried out, with the pre-embossed film 9 coated with the metal foil being held between the injection molding male mold 18 and the shaping female mold 19, the metal foil (film pattern) 12 is not damaged, and the metal foil can be transferred (for decoration) even to a product having a deeply concavo-convex surface, with its quality being ensured.

Furthermore, the film shaping male mold 17 and the injecting molding male mold 18 are moved, with the position of the film 9 coated with the metal foil being fixed, whereupon embossing and injection molding are performed. Thus, injection molding can be performed for the film 9 coated with the metal foil, which has been embossed beforehand, by the movement of the film shaping male mold 17 and the shaping female mold 19 capable of stably ensuring the accuracy of positioning without positioning the film 9 coated with the metal foil for its feeding. Besides, there is no need to perform feeding which imposes tension on the film 9 coated with the metal foil that has been under tension because of previous embossing. Hence, breakage of the metal foil 12 subjected to a deeply concavo-convex surface can be prevented reliably.

Accordingly, the metal foil 12 can be transferred (for decoration) even to a product having a deeply concavo-convex surface, with its quality being ensured, and with reliable freedom from breakage of the film 9 coated with the metal foil.

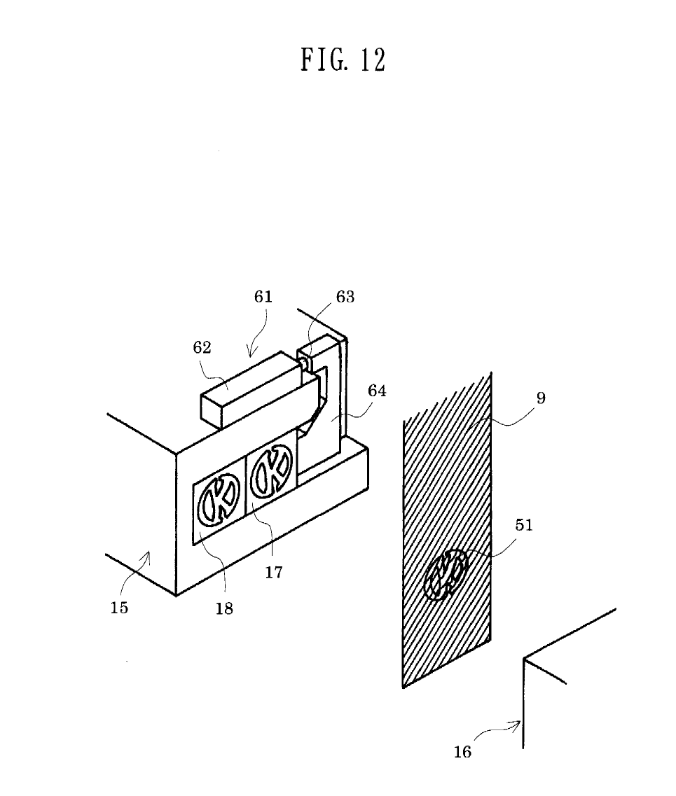

The process of an in-mold forming method by the in-mold forming apparatus having the in-mold forming mold described above will be described based on FIGS. 12 to 15. FIGS. 12 to 15 illustrate the process of the in-mold forming method according to the embodiment of the present invention.

The air cylinder 61 is driven to contract the drive rod 63, bringing the film shaping male mold 17 and the shaping female mold 19 into face-to-face relationship. In this state, the film 9 coated with the metal foil is interposed between the stationary mold body 15 and the moving mold body 16, and the moving die plate 55 (see FIG. 1) is moved to carry out clamping of the stationary mold body 15 and the moving mold body 16. By so doing, an embossed portion 51 of a shape conformed to the formed article 13 (see FIG. 5) is formed, as shown in FIG. 12. FIG. 12 shows a state in which after completion of the clamping for the predetermined embossing, the moving die plate 55 is retreated for unclamping of the stationary mold body 15 and the moving mold body 16.

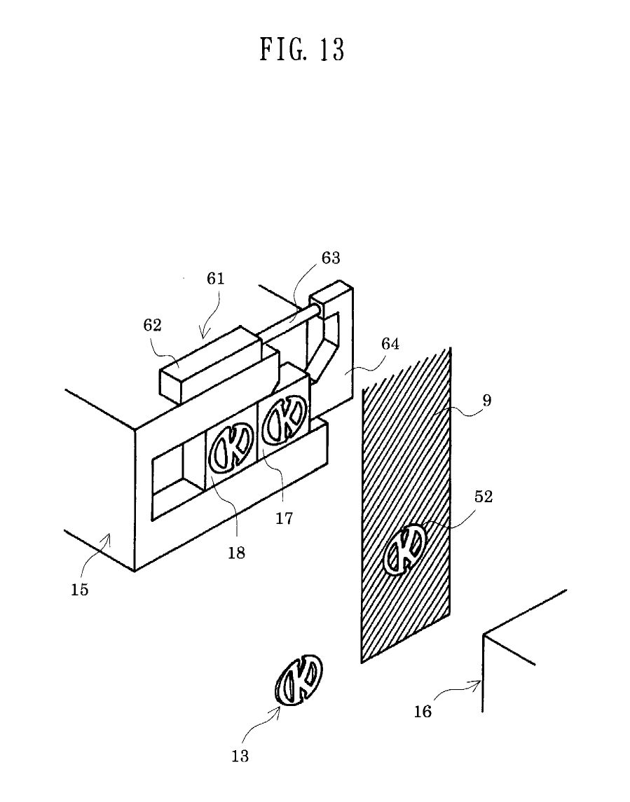

Then, with the position of the film 9 coated with the metal foil being fixed, the air cylinder 61 is driven to extend the drive rod 63, bringing the injection molding male mold 18 and the shaping female mold 19 into face-to-face relationship. In this state, the moving die plate 55 (see FIG. 1) is moved to clamp the stationary mold body 15 and the moving mold body 16 against each other, while sandwiching the embossed portion 51 between the injection molding male mold 18 and the shaping female mold 19. Under these conditions, injection molding (transfer) is carried out. As shown in FIG. 13, after completion of injection molding, the moving die plate 55 is retreated to unclamp the stationary mold body 15 and the moving mold body 16. The resulting formed article 13 is ejected from the mold, and a transfer site 52 devoid of the metal foil is left in the embossed portion 51 of the film 9 coated with the metal foil. The ejection of the formed article 13 can be performed, for example, by an ejection mechanism using a fluid.

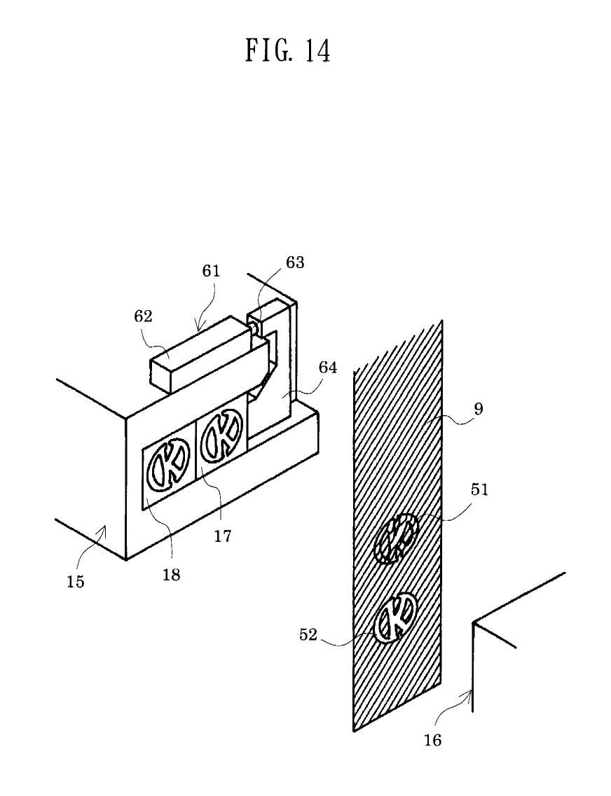

The air cylinder 61 is driven again to contract the drive rod 63, bringing the film shaping male mold 17 and the shaping female mold 19 into face-to-face relationship. Also, the feed roll 10 of the film feeding device 2 (see FIG. 1) is actuated to feed the film 9 coated with the metal foil by a predetermined amount. In this state, the moving die plate 55 (see FIG. 1) is moved to clamp the stationary mold body 15 and the moving mold body 16 against each other, while sandwiching the film 9 coated with the metal foil between the stationary mold body 15 and the moving mold body 16. By this action, an embossed portion 51 of a shape conformed to the formed article 13 (see FIG. 5) is formed again, as shown in FIG. 14. FIG. 14 shows a state in which after completion of the clamping for the predetermined embossing, the moving die plate 55 is retreated for unclamping of the stationary mold body 15 and the moving mold body 16.

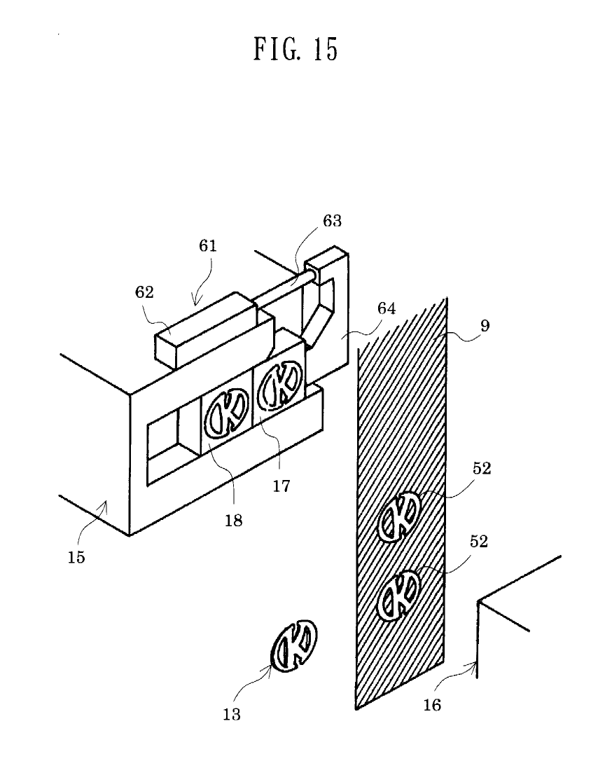

Then, with the position of the film 9 coated with the metal foil being fixed, the air cylinder 61 is driven to extend the drive rod 63, bringing the injection molding male mold 18 and the shaping female mold 19 into face-to-face relationship. In this state, the moving die plate 55 (see FIG. 1) is moved to clamp the stationary mold body 15 and the moving mold body 16 against each other, while sandwiching the new embossed portion 51 between the injection molding male mold 18 and the shaping female mold 19. Under these conditions, injection molding (transfer) is carried out. As shown in FIG. 15, after completion of injection molding, the moving die plate 55 is retreated to unclamp the stationary mold body 15 and the moving mold body 16. The resulting formed article 13 is ejected from the mold, and a new transfer site 52 devoid of the metal foil is left in the new embossed portion 51 of the film 9 coated with the metal foil.

By repeating the above-described procedure, it becomes possible to perform the film shaping and embossing, by the film shaping male mold 17 and the shaping female mold 19, of the film 9 coated with the metal foil for imparting a shape conformed to the formed article; and forming for obtaining the formed article 13, which has the metal foil transferred thereto, by injection molding while sandwiching the embossed portion 51 between the injection molding male mold 18 and the shaping female mold 19. By repeating the reciprocation of the film shaping male mold 17 and the injection molding male mold 18 and the feed of the film 9 coated with the metal foil upon mold release, moreover, the formed articles 13 each having the metal foil transferred thereto can be continuously obtained.

Thus, the metal foil 12 is not damaged, and the metal foil can be transferred (for decoration) even to a product having a deeply concavo-convex surface, with its quality being ensured. Furthermore, the film shaping male mold 17 and the injecting molding male mold 18 are moved, with the position of the film 9 coated with the metal foil being fixed, whereupon embossing and injection molding are performed. Thus, injection molding can be performed for the film 9 coated with the metal foil which has been embossed beforehand and whose positioning has been ensured. Besides, there is no need to perform feeding which imposes tension on the film 9 coated with the metal foil that has been under tension because of previous embossing. Hence, breakage of the metal foil 12 in response to a deeply concavo-convex surface can be prevented reliably.

According to the above-described in-mold forming apparatus, injection molding is carried out, with the film 9 coated with the metal foil, which has been embossed with the shape conformed to the formed article 13, being sandwiched between the injection molding male mold 18 and the shaping female mold 19 of the stationary mold body 15 and the moving mold body 16. Thus, the metal foil of the metal foil-coated film 9 is not damaged. Even for a product having a deeply concavo-convex surface, such as the formed article 13 having deep irregularities (e.g., irregularities of a depth of the order of 3 to 10 mm) at sites where angles formed by letters and edge portions are small, the metal foil of the metal foil-coated film 9 can be transferred, without damage, with the quality of the product being ensured.

As described above, the present invention can be utilized in the industrial fields of an in-mold forming mold and an in-mold forming apparatus for decorating resin with the film pattern of a patterned film, simultaneously with injection molding of the resin.

The present invention can also be utilized in the industrial field of an in-mold forming method for decorating resin with the film pattern of a patterned film, simultaneously with injection molding of the resin.

Although the present invention has been described by the above embodiments, it should be understood that the invention is not limited to these embodiments, but may be varied in many ways. For example, in the above embodiments, in-mold forming, which uses the film 9 coated with the metal foil as a patterned film and transfers the metal foil as a film pattern, has been taken as an example for illustration. However, the present invention can also be applied to other type of in-mold forming in which a picture design or a letter design is transferred. Moreover, in-mold forming, which transfers the metal foil while leaving the base film having the pattern, has been taken as an example for illustration. However, the present invention can also be applied to in-mold forming in which a patterned film is transferred, unchanged, for decoration of a product. Such changes, substitutions and alterations can be made therein without departing from the spirit and scope of the invention as defined by the appended claims.

1. An in-mold forming mold, comprising:
a male mold body;
a film shaping male mold and an injection molding male mold, provided adjacently in the male mold body, for embossing, beforehand, a patterned film with a shape conformed to a formed article,
the film shaping male mold and the injection molding male mold being supported on the male mold body to be movable in a reciprocating manner in a direction in which the film shaping male mold and the injection molding male mold are arranged side by side;
a female mold body;
a shaping female mold provided, in the female mold body, to oppose the film shaping male mold or the injecting molding male mold upon reciprocating movement of the film shaping male mold and the injection molding male mold; and
moving means, provided on the male mold body, for moving the film shaping male mold and the injection molding male mold to a position where the film shaping male mold or the injection molding male mold is opposed to the shaping female mold.

2. The in-mold forming mold according to claim 1, wherein the direction in which the film shaping male mold and the injection molding male mold are arranged side by side is a direction intersecting a feeding direction of the patterned film.

3. The in-mold forming mold according to claim 1, wherein the film shaping male mold and the injection molding male mold are provided in the male mold body via a heat insulating material.

4. The in-mold forming mold according to claim 1, wherein
the male mold body is provided with a slide guide,
the film shaping male mold and the injection molding male mold are integrally supported on the slide guide,
a body of an air cylinder, as the moving means, having a drive portion disposed along and parallel to the slide guide is provided in the male mold body, and
the film shaping male mold and the injection molding male mold which have been integrated are mounted on the drive portion of the air cylinder.

5. The in-mold forming mold according to claim 1, wherein
the patterned film which is embossed and injection molded by the male mold body and the female mold body is a film coated with a metal foil, and
the metal foil of the film coated with the metal foil is transferred, simultaneously with forming, to obtain the formed article decorated with the metal foil.

6. An in-mold forming apparatus, comprising:
a stationary support stand for supporting the male mold body according to claim 1;
a moving support stand for supporting the female mold body according to claim 1 to oppose the male mold body;
material pressure-feeding means for pressure-feeding a material for the formed article to a male mold side of the male mold body supported by the stationary support stand;
film feeding means, provided on a moving support stand side, for feeding the patterned film between the male mold body and the female mold body; and
control means for interlocking a clamping action by movement of the moving support stand, an action of moving the film shaping male mold and the injection molding male mold by the moving means, an action of feeding the patterned film by the film feeding means, and an action of pressure-feeding the material for the formed article by the material pressure-feeding means,
the in-mold forming apparatus being arranged to perform actions of
film shaping and embossing, by the film shaping male mold and the shaping female mold, of the patterned film to impart the shape conformed to the formed article, and
forming for obtaining the formed article decorated with a pattern of the patterned film by carrying out injection molding, while sandwiching the embossed patterned film between the injection molding male mold and the shaping female mold, after moving the film shaping male mold and the injection molding male mold upon mold release,
and also to feed the patterned film upon mold release after obtainment of the formed article and repeat the above actions, thereby continuously obtaining the decorated formed articles.

7. The in-mold forming apparatus according to claim 6, wherein
the patterned film is a film coated with a metal foil, and
the metal foil of the film coated with the metal foil is transferred, simultaneously with forming, to obtain the formed article decorated with the pattern of the patterned film.

8. An in-mold forming method, comprising:
embossing, beforehand, a patterned film with a shape conformed to a formed article by a film shaping male mold;
moving the film shaping male mold and a forming mold by an identical mold; and
performing injection molding, while interposing the embossed patterned film in the forming mold, to obtain the formed article decorated with a pattern of the patterned film.

9. The in-mold forming method according to claim 8, wherein
a shaping male mold opposing the film shaping male mold and the forming mold is a common shaping female mold, and
only the film shaping male mold and the forming mold are moved by the identical mold.

10. The in-mold forming method according to claim 8, wherein
the patterned film which is embossed and injection molded by a male mold body and a female mold body is a film coated with a metal foil; and
the metal foil of the film coated with the metal foil is transferred, simultaneously with forming, to obtain the formed article decorated with the metal foil.
